(19) United States
(12) Patent Application Publication
(10) Pub. No.: US 2025/0133529 A1
(43) Pub. Date: Apr. 24, 2025

(54) SYSTEMS AND METHODS FOR COMMUNICATING REFERENCE SIGNALS FOR POSITIONING

(71) Applicant: ZTE CORPORATION, Shenzhen (CN)

(72) Inventors: Focai PENG, Shenzhen (CN); Chuangxin JIANG, Shenzhen (CN); Guozeng ZHENG, Shenzhen (CN); Zhaohua LU, Shenzhen (CN); Yu PAN, Shenzhen (CN); Qi YANG, Shenzhen (CN)

(21) Appl. No.: 18/727,502

(22) PCT Filed: Jan. 20, 2022
(86) PCT No.: PCT/CN2022/072973

§ 371 Date: Jul. 9, 2024

(51) Int. Cl. H04W 64/00; H04L 5/00; H04W 24/10

(52) U.S. Cl. CPC H04W 64/00; H04L 5/0048; H04W 24/10

(57) ABSTRACT

Example implementations can include a wireless communication method of receiving, by a wireless communication device from a wireless communication node, configuration information indicating receptions of a plurality of reference signals for positioning on a plurality of frequency layers, measuring, by the wireless communication device, the reference signals for positioning on the frequency layers or a joint of frequency layers, and reporting, by the wireless communication device to a wireless communication element, a measurement result of the reference signals for positioning on the frequency layers or the joint of frequency layers.

### TECHNICAL FIELD

The present implementations relate generally to wireless communications, and more particularly to communicating reference signals for positioning.

### BACKGROUND

Currently, a requirement on positioning is rising. For example, in a park (especially in an underground park), it is not easy to find a car (especially during busy hours). However, the PRS/SRS of the 5th Generation mobile communication system (5G, New Radio access technology, 5G-NR) is bandwidth limited. Specifically, the protocol can only be transmitted within a carrier, e.g., within 100 MHz). Enlarging the bandwidth of the PRS/SRS is thus desirable to improve positioning accuracy.

### SUMMARY

Present implementations can provide a higher and improved positioning accuracy after carrier aggregation (CA). Thus, a technological solution for communicating reference signals for positioning is provided.

A wireless communication method can include receiving, by a wireless communication device from a wireless communication node, configuration information indicating receptions of a plurality of reference signals for positioning on a plurality of frequency layers, measuring, by the wireless communication device, the reference signals for positioning on the frequency layers or a joint of frequency layers, and reporting, by the wireless communication device to a wireless communication element, a measurement result of the reference signals for positioning on the frequency layers or the joint of frequency layers.

In some arrangements, the configuration information further indicates a Quasi-Co-Location (QCL) relationship of the reference signals for positioning among the plurality of frequency layers.

In some arrangements, the QCL relationship indicates that a first one of the reference signals for positioning on a first one of the plurality of frequency layers is Quasi-Co-Located (QCL'ed) with a synchronization signal or a physical broadcast channel block (SSB) on a second one of the plurality of frequency layers.

In some arrangements, the QCL relationship indicates that the a first one of the reference signals for positioning on a first one of the plurality of frequency layers is Quasi-Co-Located (QCL'ed) with a Channel State Information Reference Signal (CSI-RS) on a second one of the plurality of frequency layers.

In some arrangements, a method includes prior to the step of measuring the reference signals for positioning, reporting, by the wireless communication device to the wireless communication element, whether the wireless communication device supports measurements of the reference signals for positioning on multiple frequency layers or a joint of frequency layers.

In some arrangements, the step of measuring the reference signals for positioning further includes measuring, by the wireless communication device, a time difference between respective first paths of the reference signals for positioning on two corresponding ones of the frequency layers.

In some arrangements, the step of measuring the reference signals for positioning further includes measuring, by the wireless communication device, a time difference between respective first paths of the reference signals for positioning with PRS ID on two corresponding ones of the joint of frequency layers.

In some arrangements, the step of measuring the reference signals for positioning further includes measuring, by the wireless communication device, an angle difference between respective beam direction angles of two of the reference signals for positioning that are QCL'ed with each other, where both the reference signals for positioning are associated with a same QCL source.

In some arrangements, the step of measuring the reference signals for positioning further includes measuring, by the wireless communication device, a phase difference between two of the reference signals for positioning on two corresponding ones of the frequency layers.

In some arrangements, the step of measuring the reference signals for positioning further includes measuring, by the wireless communication device, a phase difference between two of the reference signals for positioning on two corresponding ones of the frequency layers, while measuring, by the wireless communication device, a time difference of the two reference signals for positioning.

In some arrangements, the step of reporting a measurement result further includes reporting, by the wireless communication device to the wireless communication element, a reason of failure on performing the step of measuring the reference signals for positioning where the reference signals for positioning are on the joint of frequency layers.

In some arrangements, the reason includes at least one of no support of aggregation of the plurality of frequency layers, temporarily no support of aggregation of the plurality of frequency layers, a bandwidth limitation, a radio frequency chain absence, a low signal strength, or an out-of-range measured value.

In some arrangements, the step of measuring the reference signals for positioning further includes measuring, by the wireless communication device, a Downlink Reference Signal Time Difference (DL RSTD) between the reference signals for positioning on two corresponding ones of the frequency layers or on the joint of frequency layers.

In some arrangements, a method includes prior to the step of measuring the reference signals for positioning, reporting, by the wireless communication device to the wireless communication element, a User Equipment (UE) capability of the wireless communication device, where the UE capability includes a maximum bandwidth the wireless communication device can process after aggregation of the frequency layers.

In some arrangements, a method includes receiving, by the wireless communication device through the wireless communication element from another wireless communication node, one or more measurement results associated with the frequency layers, where the another wireless communication node is a non-serving gNB.

In some arrangements, a method includes receiving, by the wireless communication device, a Paging Earlier Indication (PEI) indicating the wireless communication device to perform the step of measuring when in an RRC_Inactive state or an RRC_Idle state.

The wireless communication method of claim 1 further including receiving, by the wireless communication device, a PEI indicating the wireless communication device to perform the step of measuring on a single one of the frequency layers or on the joint of frequency layers.

In some arrangements, the measurement result is associated with at least one of Absolute Radio Frequency Channel Number (ARFCN), transmission reception point (TRP) identification (TRPID), PRS-ID, PRS-Resource-ID, or PRS-Resource-Set-ID.

In some arrangements, the measurement result is associated with one of a single one of the frequency layers, the joint of frequency layers, or a combination of multiple ones of the frequency layers.

In some arrangements, the wireless communication device is configured to measure one or more of the reference signals for positioning on the corresponding ones of the frequency layers that each have a high priority.

In some arrangements, the wireless communication device is configured to measure the reference signals for positioning within a processing window that is associated with a carrier ID or cell ID.

In some arrangements, the wireless communication device is configured to measure the reference signals for positioning within a processing window that is associated with an ID of a resource or resource set configured for the reference signals for positioning.

A wireless communication method can include receiving, by a wireless communication node from a wireless communication element, configuration information indicating transmission of a plurality of reference signals for positioning on a plurality of frequency layers, measuring, by the wireless communication node, the reference signals for positioning on the frequency layers or a joint of frequency layers, and reporting, by the wireless communication node to the wireless communication element, a measurement result of the reference signals for positioning on the frequency layers or the joint of frequency layers.

In some arrangements, the configuration information includes at least one of a reference signal resource for positioning on multiple frequency layers, a reference signal resource set for positioning on multiple frequency layers, a QCL relationship for the reference signal for positioning on multiple frequency layers, a subcarrier spacing for the said reference signal for positioning on multiple frequency layers, or a transmission power of the said reference signal for positioning on multiple frequency layers.

In some arrangements, the measurement includes at least one of a timing difference between frequency layers, a phase difference between frequency layers, an actual timing difference between frequency layers, an actual phase difference between frequency layers, an actual transmission power of the said reference signal for positioning on multiple frequency layers, a measurement reference point is on antenna connector, or a measurement reference point is on combined signal from antenna elements.

In some arrangements, the timing difference between frequency layers includes an average over a period or includes a standard deviation over a period.

In some arrangements, the reference signal for positioning includes at least one of, a carrier ID, a frequency layer ID, an ID of the joint frequency layer, an ID of the joint frequency layer with PRS ID, or an ID of the joint frequency layer with TRP ID.

In some arrangements, the reference signal for positioning includes at least one of, a reference signal for positioning within a PRS processing window, a reference signal for positioning within a PRS processing window and not transmitted when the PRS processing window collides with a high priority signal or channel, a reference signal for positioning within a PRS processing window and not transmitted when the reference signal for positioning collides with a high priority signal or channel, a reference signal for positioning on a frequency layers within a PRS processing window and not transmitted when the PRS processing window collides with a high priority signal or channel, or a reference signal for positioning on a joint of frequency layers within a PRS processing window and not transmitted when the reference signal for positioning collides with a high priority signal or channel.

In some arrangements, the high priority signal or channel includes at least one of a synchronization signal/physical broadcast channel block (SS/PBCH block, SSB), a physical downlink control channel (PDCCH), a PDCCH with exception of paging earlier indication (PEI), a physical downlink shared channel (PDSCH) of ultra-reliable low latency communication (URLLC), or a channel-state information reference signal (CSI-RS).

In some arrangements, the frequency layers include at least one of, a frequency layer with a measurement priority; or a joint of frequency layer with a measurement priority.

A wireless communication apparatus including at least one processor and a memory, where the at least one processor is configured to read code from the memory and implement a method in accordance with present implementations.

A computer program product including a computer-readable program medium code stored thereupon, the code, when executed by at least one processor, causing the at least one processor to implement a method in accordance with present implementations.

### BRIEF DESCRIPTION OF DRAWINGS

These and other aspects and features of the present implementations will become apparent to those ordinarily skilled in the art upon review of the following description of specific implementations in conjunction with the accompanying figures, wherein:

FIG. 1 illustrates an example cellular communication network in which techniques and other aspects disclosed herein may be implemented, in accordance with an implementation of the present disclosure.

FIG. 2 illustrates block diagrams of an example base station and a user equipment device, in accordance with some implementations of the present disclosure.

FIG. 3 illustrates a first state of a wireless network, in accordance with present implementations.

FIG. 4 illustrates a second state of a wireless network, in accordance with present implementations.

FIG. 5 illustrates a diagram of positioning accuracy with respect to a cumulative distribution function (CDF) in accordance with present implementations.

FIG. 6 illustrates a first transmission in accordance with present implementations.

FIG. 7 illustrates a second transmission in accordance with present implementations.

FIG. 8 illustrates a third transmission in accordance with present implementations.

FIG. 9 illustrates a fourth transmission in accordance with present implementations.

FIG. 10 illustrates a first method of communicating reference signals for positioning in accordance with present implementations.

FIG. 11 illustrates a second method of communicating reference signals for positioning further to the method of FIG. 10.

FIG. 12 illustrates a third method of communicating reference signals for positioning in accordance with present implementations.

### DETAILED DESCRIPTION

The present implementations will now be described in detail with reference to the drawings, which are provided as illustrative examples of the implementations so as to enable those skilled in the art to practice the implementations and alternatives apparent to those skilled in the art. Notably, the figures and examples below are not meant to limit the scope of the present implementations to a single implementation, but other implementations are possible by way of interchange of some or all of the described or illustrated elements. Moreover, where certain elements of the present implementations can be partially or fully implemented using known components, only those portions of such known components that are necessary for an understanding of the present implementations will be described, and detailed descriptions of other portions of such known components will be omitted so as not to obscure the present implementations. Implementations described as being implemented in software should not be limited thereto, but can include implementations implemented in hardware, or combinations of software and hardware, and vice-versa, as will be apparent to those skilled in the art, unless otherwise specified herein. In the present specification, an implementation showing a singular component should not be considered limiting; rather, the present disclosure is intended to encompass other implementations including a plurality of the same component, and vice-versa, unless explicitly stated otherwise herein. Moreover, applicants do not intend for any term in the specification or claims to be ascribed an uncommon or special meaning unless explicitly set forth as such. Further, the present implementations encompass present and future known equivalents to the known components referred to herein by way of illustration.

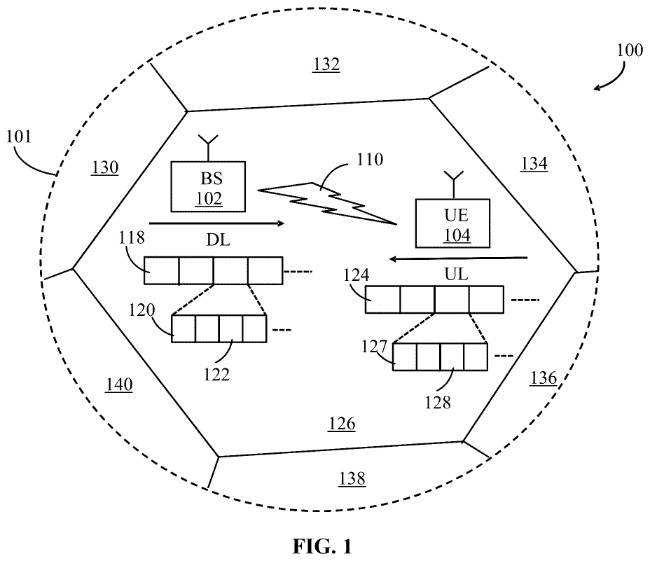

FIG. 1 illustrates an example wireless communication network, and/or system, 100 in which techniques disclosed herein may be implemented, in accordance with an implementation of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”) and a user equipment device 104 (hereinafter “UE 104”) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various implementations of the present solution.

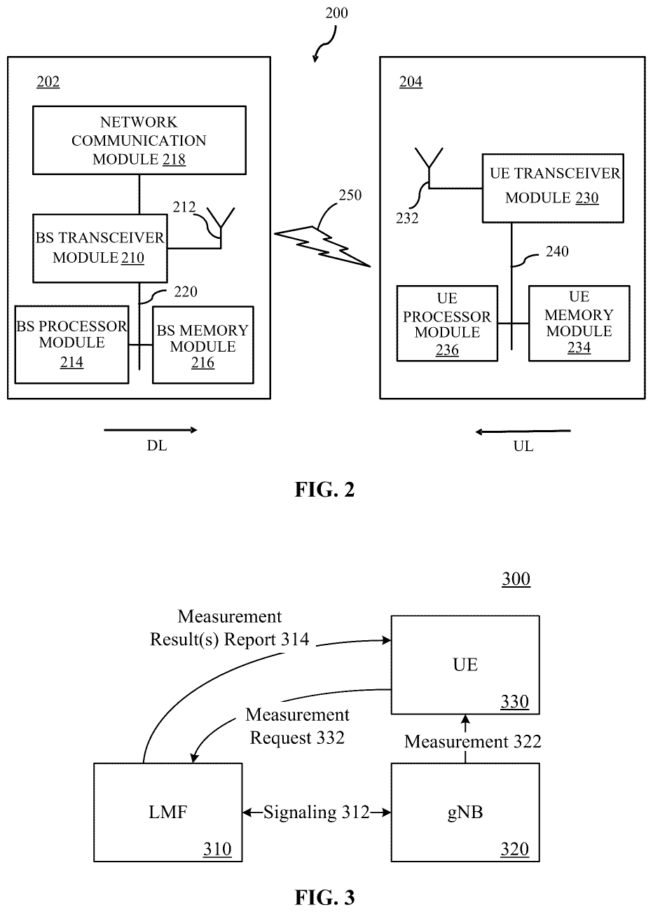

FIG. 2 illustrates a block diagram of an example wireless communication system 200 for transmitting and receiving wireless communication signals, e.g., OFDM/OFDMA signals, in accordance with some implementations of the present solution. The system 200 may include components and elements configured to support known or conventional operating features that need not be described in detail herein. In one illustrative implementation, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the implementations disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some implementations, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some implementations, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 can be coordinated in time such that the uplink receiver circuitry is coupled to the uplink antenna 232 for reception of transmissions over the wireless transmission link 250 at the same time that the downlink transmitter is coupled to the downlink antenna 212. In some implementations, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative implementations, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various implementations, the BS 202 may be an evolved node B (eNB), a serving eNB, a target eNB, a femto station, or a pico station, for example. In some implementations, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the implementations disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some implementations, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

FIG. 3 illustrates a first state of a wireless network, in accordance with present implementations. As illustrated by way of example in FIG. 3, an example wireless network 300 can include an LMF 310, a gNB 320, and a UE 330. A signaling communication 312 can include a bidirectional communication between the LMF 310 and the gNB 320. A measurement communication 322 can include a communication between the UE 330 and the gNB 320. A measurement request communication 332 can include a communication between the UE 330 and the LMF 310. A measurement result report communication 314 can include a communication between the UE 330 and the LMF 310.

In the downlink (DL), the PRS can be transmitted by one or multiple gNB. As one example, the PRS can be transmitted to achieve a “good” positioning accuracy, and can include multiple gNB, e.g., three base stations. A UE can measure the PRS and report the measurement resultor results to a network. As one example, these can include a Location Management Function (LMF), in the Core Network (CN, 5G CN, 5GC).

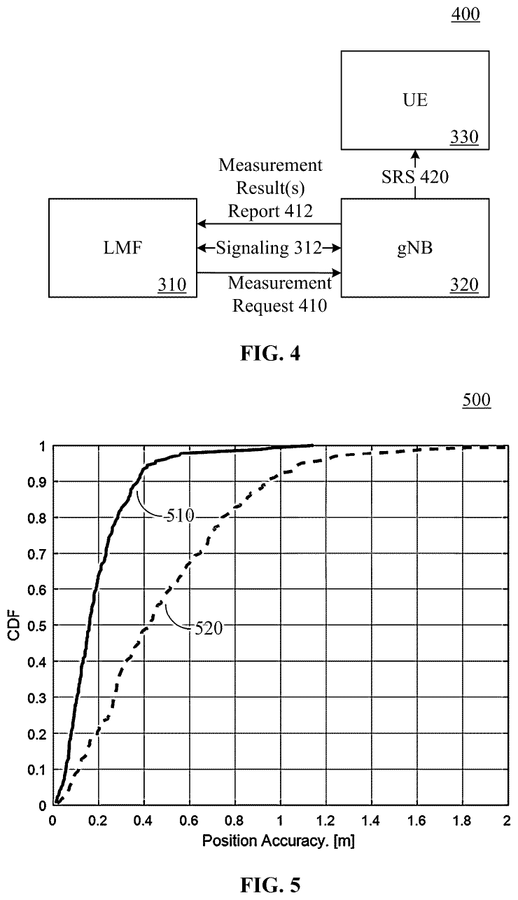

FIG. 4 illustrates a second state of a wireless network, in accordance with present implementations. As illustrated by way of example in FIG. 4, an example wireless network 400 can include the LMF 310, the gNB 320, and the UE 330. The signaling communication 312 can include a bidirectional communication between the LMF 310 and the gNB 320. An SRS communication 420 can include a communication between the UE 330 and the gNB 320. A measurement request communication 410 can include a communication between the gNB 320 and the LMF 310. A measurement result report communication 412 can include a communication between the gNB 320 and the LMF 310.

In the uplink (UL), the SRS can be transmitted by one UE. One or multiple gNB can measure the SRS and report the measurement result(s) to network. Both PRS and SRS for purpose of positioning can be transmitted within a carrier. For data transmission, aggregation of multiple component carriers (CC), i.e., carrier aggregation (CA) can achieve a high bandwidth. The CA can be an aggregation within a frequency band (intra-band CA) or, inter-frequency band (inter-band CA). The principle of CA might be also applied to PRS and SRS for purpose of positioning.

One example takes DL-PRS as description. However, its principle can also be applied to UL-SRS. First, a network (including base station and CN) can configure PRS resource(s)/PRS resource set(s) for base station and UE. A network can provide configuration information of PRS resource(s)/PRS resource set(s) for a base station and/or a UE on assistance data. The PRS resource(s)/PRS resource set(s) can have one or more component carriers. As one example, component carriers can include one or more of frequency layers (FL), positioning frequency layers (PFL); e.g., on 2 CC. A CC can be identical to a frequency layer. A carrier can be identical to a frequency layer. A CC can be identical to a frequency layer. A carrier can be identical to a positioning frequency layer. A downlink carrier can be identical to a frequency layer. A downlink carrier with reference signal for positioning can be identical to a frequency layer. A downlink carrier with PRS can be identical to a frequency layer. A downlink carrier with SRS can be identical to a frequency layer. A frequency layer can include one or more CC. A frequency layer can include a part of CC (e.g., partial bandwidth, some physical resource block, some PRB). The PRS resource(s) can be on two or more contiguous CC. The PRS resource(s) can be on two or more separated CC (i.e., noncontiguous CC). The PRS resource(s) can be on BWP from two or more CC.

The base station reports timing offset (or timing difference) between/among CC to the network (e.g., LMF). The base station reports timing drift between/among CC to the network. The base station reports timing offset measured on the antenna connector between/among CC to the network. The base station reports timing offset measured on the combined signal from antenna elements between/among CC to the network. Alternatively, if there can be no timing offset, a zero can be reported (such as for contiguous CC with identical antenna). To reduce signaling overhead, if the timing offset can be zero, there can be no report on timing drift between/among CC.

There can be a reference carrier (or cell, or serving cell) when the base station reports timing offset between/among CC. The reference carrier can be a carrier with the lowest frequency. The reference carrier can be a carrier with the highest frequency. The reference carrier can be a carrier on frequency range 1 (FR 1, i.e., 0.5-6 GHz). The reference carrier can be a carrier on frequency range 2 (FR 2, i.e., 24-52 GHz). Alternatively, if there can be a CC on FR 1, then the reference carrier can be a carrier on FR 1. Alternatively, if there can be a CC on FR 2, then the reference carrier can be a carrier on FR 2.

The reported timing offset between/among CC has a range with a unit of nanosecond (ns), e.g., 0-10 ns. The reported timing offset between/among CC has a range of −10˜+10 ns. It can be noted that, a positive value for being ahead of another carrier while a negative for lagging behind of another carrier. The reported timing offset between/among CC can be in a unit of Tc=1/(Δf*FFT) where Δf=480 kHz and FFT=4096. Alternatively, the reported timing offset between/among CC can be in a granularity of Tc. Alternatively, the reported timing offset between/among CC can be in a granularity of ½\hat{ }32 second. The reported timing offset can be in a range of 0˜32 Tc. The reported timing offset can be in a range of −32˜+32 Tc. The reported timing offset can be with a unit of Tc/2 or Tc/4 (e.g., Δf=960 kHz or 1920 kHz with identical FFT size).

The reported timing offset can be defined as the time difference between two CC. The reported timing offset can be defined as the time difference between two CC when these two CC reach their peak power. The reported timing offset can be defined as the time difference between two CC when these two CC reach their peak power from zero power. The reported timing offset can be defined as the nearest time gap between two CC when these two CC reach their peak power from zero power. The reported timing offset can be defined as the nearest time gap between two CC when these two CC reach half of their peak power from zero power. The reported timing offset can be defined as the nearest time gap between two CC when these two CC reach their−3 dB power from zero power.

The base station reports phase offset between/among CC to the network (e.g., LMF). The phase offset has a range of 0˜2π or −π˜+π. There can be a reference carrier when measuring phase offset. There can be a reference carrier in each carrier group when measuring phase offset. There can be a reference carrier in each cell group (e.g., master cell group, MCG, secondary cell group, SCG) when measuring phase offset. The phase offset between CC can be defined on resource element (RE) base. The phase offset between two CC can be defined as the phase difference when one CC can be in phase zero what the phase of the other CC can be.

Alternatively, the base station reports Rx-Tx time difference to the network (e.g., the LMF). Alternatively, the base station reports Rx-Tx time difference between CC/FL to the network. Alternatively, the base station reports Rx-Tx time difference between jointed CC/FL to the network. Alternatively, the base station reports Rx-Tx time difference between combined CC/FL to the network. Alternatively, the base station reports Rx-Tx time difference measured on jointed CC/FL to the network. Alternatively, the base station reports Rx-Tx time difference measured on combined CC/FL to the network.

Secondly, the network (e.g., the LMF) can configure base station(s) (e.g., the gNB) to transmit one or more PRS.

Thirdly, the base station(s) (e.g., the gNB) transmit(s) one or more PRS. The base station can measure actual timing offset(s) between/among CC. After that, the base station can report actual timing offset(s) between/among CC to the network (e.g., LMF). The actual timing offset(s) between/among CC can have the same range and unit as those in the first step.

The actual timing offset(s) between/among CC can be/are averaged over a period (e.g., one slot or one radio frame). The actual timing offset(s) between/among CC can be/are standard deviation (STD) within a period. There are N measurement samples within this period where the N can be a positive integer (e.g., N=10). The reported value of can have the same range and unit as those in the first step.

The base station can measure actual timing offset(s) between/among CC at base of per band. The actual timing offset per band can be at base of reference CC (or FL). The actual timing offset can be the timing offset between one CC and the reference CC. The reference CC can have a carrier index (or serving cell index, e.g., 0).

The base station (e.g., the gNB) transmits PRS with carrier ID. The base station (e.g., the gNB) transmits PRS with carrier ID (or serving cell ID) when generating PRS sequence (or PRS signal). The base station (e.g., the gNB) transmits PRS with carrier ID (or serving cell ID) when generating PRS sequence (or PRS signal) during sequence initialization (e.g., in the initialization seed c_init) as the following.

$$Eqn . ( 1 )$$

$${c}_{init} = ( {2}^{22} ⌊ \frac{{n}_{ID , seq}^{PRS}}{1024} ⌋ + {2}^{10} ( {N}_{symb}^{slot} {N}_{s , f}^{μ} + l + 1 ) ( 2 ( {n}_{ID , seq}^{PRS} mod 1024 ) + 1 ) + ( {n}_{ID , seq}^{PRS} mod 1024 ) + CC\_ID ) mod {2}^{31}$$

where n_{s,f}^{μ} can be the slot number, the downlink PRS sequence ID n_{ID,seq}^{PRS} ∈ {0,1, . . . ,4095}can be given by the higher-layer parameter DL-PRS-SequenceId, l can be the OFDM symbol within the slot to which the sequence can be mapped, N_{symb}^{slot} can be number of symbols per slot, n_{s,f}^{μ} can be lot number within a frame for subcarrier spacing configuration μ, mod can be a modular operation, “└•┘” fetches an integer that can be not greater than the operand, and CC_ID can be carrier ID (or serving cell ID).
   The base station (e.g., the gNB) transmits PRS with SSB index as the following initialization seed c_init where the SSB_Index can be SSB index.

$$Eqn . ( 2 )$$

$${c}_{init} = ( {2}^{22} ⌊ \frac{{n}_{ID , seq}^{PRS}}{1024} ⌋ + {2}^{10} ( {N}_{symb}^{slot} {N}_{s , f}^{μ} + l + 1 ) ( 2 ( {n}_{ID , seq}^{PRS} mod 1024 ) + 1 ) + ( {n}_{ID , seq}^{PRS} mod 1024 ) + SSB\_Index ) mod {2}^{31}$$

The base station (e.g., the gNB) can transmit PRS with a certain value of power (or energy) per resource element (EPRE) on a CC/FL. Alternatively, the EPRE on each CC/FL is identical. Alternatively, the EPRE of PRS on each CC/FL is informed to UE.

The base station (e.g., the gNB) can measure transmission power of each CC/FL. The base station (e.g., the gNB) reports transmission power of each CC/FL to the network (e.g., the LMF). The base station (e.g., the gNB) reports transmission power of each CC/FL to a UE. The base station (e.g., the gNB) reports transmission power of each CC/FL to its serving UE. The network (e.g., the LMF) forwards the measurement result(s) (e.g., transmission power of each CC/FL, time offset between CC/FL) to a UE. The network (e.g., the LMF) forwards the measurement result(s) from neighboring cell(s) to a UE.

Fourthly, a UE measures one or more PRS from the base station(s). The measurement results include DL PRS reference signal received power (DL PRS-RSRP), DL reference signal time difference (DL RSTD), UE Rx-Tx time difference, reference signal antenna relative phase (RSARP), DL Angle of Departure (DL AoD), time difference of arrival signal between carriers. The time difference between carriers can have the same range and unit as those in the first step.

Alternatively, the UE measures Rx-Tx time difference. Alternatively, the UE measures Rx-Tx time difference of RS for positioning (e.g., the Rx-Tx time difference is counted from PRS receiving to SRS transmission). Alternatively, the UE measures Rx-Tx time difference between CC/FL. Alternatively, the UE measures Rx-Tx time difference between jointed CC/FL. Alternatively, the UE measures Rx-Tx time difference between combined CC/FL. Alternatively, the UE measures Rx-Tx time difference on jointed CC/FL. Alternatively, the UE measures Rx-Tx time difference on combined CC/FL. Alternatively, the UE measures Rx-Tx time difference on combined CC/FL with an uncertainty (e.g., uncertainty from LMF).

Alternatively, before measuring PRS, a UE can report its UE capability whether it supports aggregation CC or not. Alternatively, before measuring PRS, a UE can report its UE capability whether it supports measuring on multiple CC or not. Alternatively, this UE capability can be defined on per band (e.g., UE on one frequency band may support this capability while not for another frequency band). Alternatively, this UE capability can be defined on per band combination (e.g., UE on a set of frequency bands may support this capability). Alternatively, this UE capability can include a maximum bandwidth it can process after aggregation of CC (e.g., 4*100=400 MHz, 4 CC, 100 MHz each). Alternatively, this UE capability can include a maximum number of CC it can process (e.g., at most 4 CC). Alternatively, this UE capability can include a maximum number of frequency layers it can process (e.g., at most 8 layers).

Alternatively, if the measurement of PRS (e.g., PRS with aggregation of CC) fails, a UE can report its reason of failure. The reason of failure can be no support of aggregation of CC, bandwidth limitation, RF chain absent, low signal strength, the measured value being out of range.

The measurement of PRS can be in a PRS processing window (e.g., outside of measurement gap, outside of MG). The measurement of PRS can be within a MG. A UE measures all the PRS of each CC in a PRS processing window. A UE measures all the PRS of each CC in a PRS processing window within a time instance.

The PRS measured by a UE can be within a PRS processing window. The PRS measured by a UE can be within a measurement gap (MG). The PRS measured by a UE can be within a PRS processing window for this UE with a kind of UE capability. The PRS measured by a UE can be within a measurement gap (MG) for this UE with another kind of UE capability.

The PRS measured by a UE can be within a PRS processing window for this UE with a kind of UE capability which this UE capability can be based on frequency band (e.g., per band). The PRS measured by a UE can be within a PRS processing window for this UE with a kind of UE capability which this UE capability can be based on frequency band within FR 1. The PRS measured by a UE can be within a PRS processing window for this UE with a kind of UE capability which this UE capability can be based on frequency band within FR 2. The PRS measured by a UE can be within a PRS processing window for this UE with a kind of UE capability which this UE capability can be based on frequency band combination (e.g., per band combination). The PRS measured by a UE can be within a PRS processing window for this UE with a kind of UE capability which this UE capability can be based on UE itself (e.g., per UE).

Alternatively, the UE measures the carrier phase of reference signal for positioning (e.g., PRS) on a CC/FL. Alternatively, the UE measures the carrier phase of PRS on a radio propagation path on a CC/FL. Alternatively, the UE measures the carrier phase of PRS on the first path on a CC/FL. Alternatively, the UE measures the carrier phase of PRS on the first path on a CC/FL with an indication of line of sight (LOS)/non-LOS (NLOS). Alternatively, the UE measures the carrier phase of PRS on the first path on a CC/FL with an indication of probability of LOS/NLOS (e.g., 90% probability of LOS). Alternatively, the UE measures the carrier phase of PRS on the first path on a CC/FL with an indication of LOS/NLOS under a certain level of confidence probability (e.g., 95% confidence level). Alternatively, the UE can measure the carrier phase of PRS on the first path on a joint of CC/FL with an indication of loss of signal (LOS) or no loss of signal (NLOS) under a certain level of confidence probability. Alternatively, the carrier phase of reference signal for positioning can be referred to the carrier phase difference between base station and UE itself of reference signal for positioning.

Alternatively, the UE can measure the carrier phase difference of PRS for positioning between CC/FL with an indication of LOS/NLOS.

Alternatively, the UE can measure the carrier phase difference between base station and UE itself of reference signal for positioning on a CC/FL with an indication of LOS/NLOS. Alternatively, the UE can measure the carrier phase difference between base station and UE itself of reference signal for positioning on a joint of CC/FL with an indication of LOS/NLOS.

Fifthly, a UE reports its measurement result(s) to the network (e.g., LMF). Alternatively, the UE reports the carrier phase of reference signal for positioning (e.g., PRS) on a CC/FL with an indication of LOS/NLOS. Alternatively, the UE reports the carrier phase of PRS on the first path on a CC/FL with an indication of LOS/NLOS. Alternatively, the UE reports the carrier phase of PRS on the first path on a CC/FL with an indication of LOS/NLOS. Alternatively, the UE reports the carrier phase of PRS on the first path on a CC/FL with an indication of LOS/NLOS under a certain level of confidence probability (e.g., 99% confidence level). Alternatively, the UE reports the carrier phase of PRS on the first path on a joint of CC/FL with an indication of LOS/NLOS under a certain level of confidence probability (e.g., 90% confidence level).

Alternatively, the UE reports the carrier phase difference of reference signal for positioning (e.g., PRS) between CC/FL with an indication of LOS/NLOS.

Alternatively, the UE can report the carrier phase difference between base station and UE itself of reference signal for positioning (e.g., PRS) on a CC/FL with an indication of LOS/NLOS. Alternatively, the UE reports the carrier phase difference between base station and UE itself of reference signal for positioning on a joint of CC/FL with an indication of LOS/NLOS.

Sixthly, the network (e.g., LMF) calculate the position of UE according to the measurement result(s) from base station and/or UE. The network (e.g., LMF) can discard a measurement result from base station and/or UE. Alternatively, under the circumstance that two or more CC are on different radio frequency (RF) chains for the PRS/SRS transmission, measurement and report, the same principle above can be applied.

FIG. 5 illustrates a diagram of positioning accuracy with respect to a cumulative distribution function (CDF) in accordance with present implementations. As illustrated by way of example in FIG. 5, an example diagram can include a first accuracy curve 510 and a second accuracy curve 520.

Positioning accuracy can be improved from 0.95m @CDF=90% to 0.38m @CDF=90%. Carrier frequency=3.5 GHz, CC1=50 MHz, CC2=50 MHz, CCl can be separated with 50 MHz apart from CC2, the timing drift between CC1 and CC2 can be 3 ns in standard deviation (STD), with respect to an Indoor Factory with Sparse clutter and High base station height (InF-SH).

This example takes UL-SRS as description. However, its principle can also be applied to DL-PRS and/or channel-state information reference signal (CSI-RS). First, a network (including base station and CN) configure SRS resource(s)/SRS resource set(s) for base station and UE (e.g., via assistance data). The SRS resource(s)/SRS resource set(s) can be on different CC. The SRS resource(s)/SRS resource set(s) can be on different CC within a band (i.e., intra-band CA). The SRS resource(s)/SRS resource set(s) can be on different bandwidth part (BWP) on different CC within a band. The SRS resource(s)/SRS resource set(s) can be on different BWP on different CC on different frequency bands.

It can be noted that, before the configuration of SRS resource(s)/SRS resource set(s), the network (e.g., the LMF) can request a device (e.g., the UE) to report its positioning (measurement) capability and provide necessary configuration information of SRS (e.g., via assistance data).

Secondly, the UE transmits SRS according to the configuration of SRS.

Thirdly, the UE measures the timing difference between CC. The UE measures the timing difference of SRS between CC. The UE measures the timing difference of SRS for positioning between CC. The UE measures the timing difference between one reference carrier and other CC. Alternatively, reference carrier can be a carrier with lowest carrier index (or, serving cell index). Alternatively, reference carrier can be a carrier with a carrier index 0. Alternatively, reference carrier can be a carrier with lowest carrier frequency.

The UE measures the phase difference between CC. The UE measures the phase difference of SRS between CC. The UE measures the phase difference of SRS for positioning between CC. The UE measures the carrier phase difference of SRS for positioning between CC.

Fourthly, the UE report the timing difference and/or the phase difference to the network (e.g., LMF, gNB). A kind of UE capability of ensuring a certain timing difference between CC can be defined. For example, if a UE can ensure 2 nanoseconds timing difference between CC, it can declare itself with a capability of supporting CA.

Fifthly, the network (e.g., gNB) measures the timing difference between CC. The network (e.g., gNB) measures the timing difference of SRS between CC. The network (e.g., gNB) measures the timing difference of SRS for positioning between CC. The network (e.g., gNB) measures the timing difference of the first path of SRS for positioning between CC. The network (e.g., gNB) measures the timing difference of the first path of SRS for positioning between CC where the first path has a power being higher than a threshold (e.g., −130 dBm).

The network (e.g., gNB) measures the carrier phase difference between CC. The network (e.g., gNB) measures the carrier phase difference of SRS between CC. The network (e.g., gNB) measures the carrier phase difference of SRS for positioning between CC. The network (e.g., gNB) measures the carrier phase difference of the first path of SRS for positioning between CC.

The network (e.g., gNB) measures the carrier phase difference at center frequency between CC. The network (e.g., gNB) measures the average carrier phase difference over all sub-carriers of each CC between CC. The carrier phase difference can be averaged over all sub-carriers of within a CC. It can be noted that, this step can be after the second step without any effect of the positioning result.

Sixthly, the network (e.g., gNB) reports measurement result(s) (e.g., timing difference and/or the phase difference) to the network (e.g., LMF) and/or UE. For the case of measurement result(s) being reported to the UE, the UE can calibrate its timing/phase between two carriers which can improve the positioning accuracy. A neighboring cell (e.g., non-serving gNB) reports measurement result(s) (e.g., timing difference between CC/FL, arrival time of a CC/FL) to a UE (e.g., via forwarding by a LMF). It can be noted that, this step can be after the second step without any effect of the positioning result.

Seventhly, the network (e.g., LMF) compute the position of UE according to the measurement result(s) from gNB and/or UE. With this method, the UL-based positioning accuracy can be improved.

For a UE under radio resource control Inactive (RRC_Inactive) state, if this UE had been configured with two or more CC (or serving cells) with configuration of reference signal for positioning before it entering RRC_Inactive state, this UE can perform positioning related operation (e.g., measurement, report) as those in Detailed Example 1 above. It can be noted that, the principle can be applied for UE under RRC_Connected state.

First, a network (including base station, LMF) configure PRS resource(s)/PRS resource set(s) for base station and UE. Secondly, the base station(s) (e.g., the gNB) transmit(s) one or more PRS.

Thirdly, a UE measures one or more PRS. A UE measures PRS on one carrier (i.e., one frequency layer). A UE measures timing difference of PRS on one carrier. A UE measures timing difference of PRS from two or more base station on one carrier. A UE measures timing difference of the first path of PRS from two or more base station on one carrier. A UE measures timing difference of the first path of PRS from two or more base station on joint two or more carriers (i.e., two or more frequency layers). For example, for joint two frequency layers with each of 100 MHz, a UE can measure PRS over 100*2=200 MHz bandwidth. A UE measures phase difference of the first path of PRS from two or more base station on joint two or more carriers (i.e., two or more frequency layers). A UE under RRC_Inactive (even RRC_Idle) state measures PRS according to indication from paging earlier indication (PEI). A PEI can indicate a UE whether a UE measures PRS or not. A PEI can indicate a UE whether a UE measures PRS on a single CC/FL or not. A PEI can indicate a UE whether a UE measures PRS on a joint of multiple CC/FL or not. A PEI can indicate a UE whether a UE measures PRS on a single CC/FL or a joint of multiple CC/FL. A PEI can have one or two bit(s) for CC/FL indication (e.g., a single CC/FL or a joint of multiple CC/FL). A UE under RRC_Inactive (even RRC_Idle) state measures PRS according to indication from RRC configuration (e.g., from RRC release signaling). A UE under RRC_Inactive (even RRC_Idle) state measures PRS according to indication from system information block (SIB).

Fourthly, a UE reports its measurement result(s) to the network (e.g., LMF). A report can be associated with at least one of the following: Absolute Radio Frequency Channel Number (ARFCN), transmission reception point (TRP) identification (TRPID), PRS-ID, PRS-Resource-ID, PRS-Resource-Set-ID. A report can be related to at least one of the following within a timing error group (TEG, Rx TEG, receiving TEG, e.g., same TRP, same Rx panel, Rx-Tx TEG, receiving-transmission TEG): ARFCN, TRPID, PRS-ID, PRS-Resource-ID, and PRS-Resource-Set-ID.

An ARFCN can be for one frequency layer. An ARFCN can be for a joint of two or more frequency layers. A TRPID can be an ID of TRP that transmits/receives reference signal for positioning. A PRS-ID can be an ID of PRS transmitted on a TRP. A PRS-ID can be associated with one or more TRPID. A PRS has one or more PRS-Resource-Set with PRS-Resource-Set-ID. A PRS has one or more PRS-Resource with PRS-Resource-ID.

A report of timing difference of the first path of PRS from two or more base station can indicate whether it can be for one frequency layer or a joint of multiple frequency layers. A UE can report one of the following measurement result(s) (e.g., time difference between two base station/TRP), including at least one of a measurement result(s) for single CC/FL, a measurement result(s) for a joint of multiple CC/FL, or a measurement result(s) for a combination of multiple CC/FL. A UE reports measurement result(s) with one or more set ID (e.g., PRS-ID, PRS-Resource-ID, PRS-Resource-Set-ID, TRP-ID, gNB-ID, cell ID, serving cell ID). A measurement result can be associated with an indication whether it can be for a single CC/FL or a joint of multiple CC/FL. A CC/FL can be with a measurement priority. A UE can measure a CC/FL (or a joint of multiple CC/FL) with high priority. A UE can report a CC/FL (or a joint of multiple CC/FL) with high priority (e.g., a joint of multiple CC/FL first). A UE can measure RSTD of a CC/FL (or a joint of multiple CC/FL) with high priority (e.g., a joint of multiple CC/FL first). Fifthly, the network (e.g., LMF) calculate the position of UE according to the measurement result(s) from base station and/or UE. With this method, the DL-based positioning accuracy can be improved.

First, the network (e.g., gNB) can configure Quasi-Co-Location (QCL) relationship of PRS in each CC for a UE. The PRS on one carrier can be QCL with synchronization signal/physical broadcast channel block (SS/PBCH block, SSB) on its own carrier (or cell). For example, the first PRS resource (set) can be QCL with SSB with index 0 on its own carrier. For another example, the second PRS resource (set) can be QCL with SSB with index 1 on its own carrier. The PRS on one carrier can be QCL with SSB on another carrier. For example, the PRS on one carrier with carrier index 0 (or, serving cell index 0) can be QCL with SSB on another carrier with carrier index 1 (or, serving cell index 1). For another example, the first PRS resource (set) on one carrier with carrier index 0 can be QCL with SSB with a SSB index 0 on another carrier with carrier index 1. The PRS on one carrier can be QCL with SSB on a reference carrier. The reference carrier has a lowest frequency. The reference carrier has a lowest center frequency. The reference carrier has a lowest Absolute Radio Frequency Channel Number (ARFCN). The reference carrier can be on FR 1. The reference carrier can be on FR 2. The reference carrier can be a QCL source of PRS.

The PRS on one carrier can be QCL with channel-state information reference signal (CSI-RS). The PRS on one carrier can be QCL with CSI-RS on its own carrier. The PRS on one carrier can be QCL with CSI-RS on another carrier. The PRS on one carrier can be QCL with another PRS. The PRS on one carrier can be QCL with another PRS on its own carrier. The PRS on one carrier can be QCL with another PRS on another carrier. For example, the PRS on a carrier with carrier index 0 can be QCL with another PRS on a carrier with carrier index 1. Secondly, the network (e.g., gNB) transmits the PRS.

Thirdly, a UE measures the PRS. A UE can measure beam direction (angle) of PRS. A UE can measure beam direction (angle) of PRS with QCL with the same QCL source. A UE can measure beam direction (angle) of PRS with QCL with the same SSB. A UE can measure beam direction (angle) of PRS with QCL with the same CSI-RS. A UE can measure beam direction (angle) of PRS with QCL with different QCL source. A UE can measure phase difference of PRS between two CC with QCL with the same QCL source. The reference point for measurement can be on antenna connector.

Fourthly, a UE reports measurement result(s). A UE can report beam direction angle difference. A UE can report beam direction angle difference between two PRS. A UE can report beam direction angle difference between two PRS with QCL with the same QCL source. A UE can report beam direction angle difference between two PRS on difference carriers (or frequency layers) with QCL with the same QCL source. A UE can report beam direction angle difference between two PRS on difference carriers with QCL with the same SSB. A UE can report beam direction angle difference between two PRS on difference carriers with QCL with different QCL source. A UE can report beam direction angle difference when performing measurement of DL AoD. A UE can report phase difference of PRS between two CC when performing measurement of DL RSTD.

Fifthly, the network (e.g., LMF) calculate the position of UE according to the measurement result(s) from UE and/or base station configuration of QCL relationship. Alternatively, for SRS transmission, measurement and report, the same principle for PRS can be applied to SRS. Alternatively, for SRS transmission, measurement and report, association between SRS and SSB can be configured. For example, the first SRS resource (set) can be associated with a SSB with SSB index 0. Alternatively, for SRS transmission, measurement and report, association between SRS and CSI-RS can be configured. For example, the second SRS resource (set) can be associated with a CSI-RS resource with index 1. With this method, the positioning accuracy can be improved.

First, the network (e.g., gNB) can configure sub-carrier spacing (SCS) of PRS in each CC. For example, the SCS of PRS in the first CC can be 15 kHz while 30 kHz for the PRS in the second CC. Secondly, the network (e.g., gNB) transmits the PRS. Thirdly, a UE measures the PRS. A UE measures path RSRP (e.g., RSRP of 8 paths) of the PRS. A UE measures time of arrival of each path of the PRS. A UE measures time difference of the first path of the PRS between two CC. Fourthly, a UE reports measurement result(s) above to the network (e.g., LMF).

Fifthly, the network (e.g., LMF) calculate the position of UE according to the measurement result(s) from UE and/or base station configuration of SCS. The network can select the measurement result(s) from one CC while discard others′. The network can select the measurement result(s) from one CC with a higher SCS. The network can select the measurement result(s) from one CC with a higher SCS if the path RSRP of the first path can be higher than some value (e.g., −120 dBm).

Alternatively, for a UE under radio resource control Inactive (RRC_Inactive) state, if this UE had been configured with two or more CC (or serving cells) before it entering RRC_Inactive, this UE can perform measurement and report as those in the third and fourth step. Alternatively, only time difference between CC can be measured and reported for a UE under RRC_Inactive state. Alternatively, only time difference and phase difference between CC are measured and reported for a UE under RRC_Inactive state. The measurement result(s) can be/are reported via a mechanism of small data transmission for a UE under RRC_Inactive state. The measurement result(s) can be/are reported via message B (MsgB) for a UE under RRC_Inactive state. Alternatively, only time difference between CC with identical SCS can be measured and reported for a UE under RRC_Inactive state. Alternatively, only time difference between CC with different SCS can be measured and reported for a UE under RRC_Inactive state. With this method, the positioning accuracy can be improved.

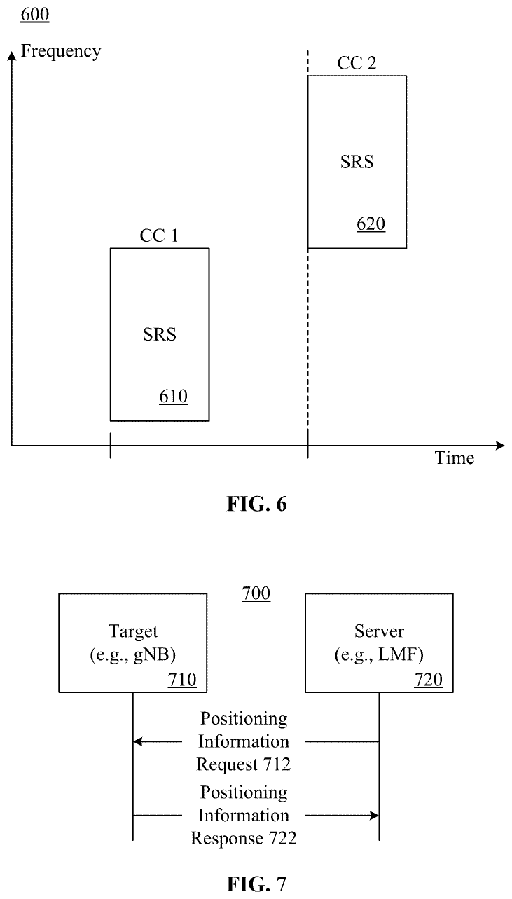

FIG. 6 illustrates a first transmission in accordance with present implementations. As illustrated by way of example in FIG. 6, an example transmission 600 can include a first SRS resource 610 and a second SRS resource 620.

For uplink transmission, because of limited power of UE (e.g., 200 mW, i.e., 23 dBm), the bandwidth of uplink signal (e.g., SRS for positioning) can be limited (especially for a UE being far away from its serving base station). However, a higher bandwidth can be a key factor to improve positioning accuracy. To this end, this disclosure gives some solutions on it.

First, a network (including base station and CN) configure SRS resource(s)/SRS resource set(s) for base station and UE (e.g., via assistance data). The configured SRS resource(s)/SRS resource set(s) include(s) at least two CC. The configured SRS resource(s)/SRS resource set(s) include(s) at least two contiguous CC. The configured SRS resource(s)/SRS resource set(s) include(s) at least two noncontiguous or separated CC.

Secondly, according to the configuration of SRS, the UE transmits SRS on a first carrier at a first time and another SRS on a second carrier at a second time as the following figure.

In this figure, the start time of SRS on CC 1 can be t1 while t2 for the start time of SRS on CC2. The time gap can be t2-t1. The time gap can be in unit of nanosecond. The time gap can be in unit of Tc or Ts (as defined in Detailed Example 1). For example, the time gap can be 140288 Tc or 2192 Ts (i.e., one symbol with 144 Ts in cyclic prefix at a SCS=15 kHz. It can be noted that, for one symbol with 160 Ts in cyclic prefix at a SCS=15 kHz, a symbol has 2208 Ts=141312 Tc in time duration). The time gap can be defined as one or more symbols plus additional time as the following.

$$Gap\_in \_Tc = 140288 * NumberOfSymbol + FractionPart \qquad Eqn . ( 3 )$$

Where Gap_in_Tc can be the time gap in unit of Tc, NumberOfSymbol can be number of symbol between these two SRS (from t1 to t2), the FractionPart can be a time duration less than a symbol with a unit of Tc (i.e., FractionPart<140288). It can be noted that, for a time gap having both symbol with short cyclic prefix (CP, e.g., 144 Ts) and symbol with long CP (e.g., 160 Ts), the NumberOfSymbol can be calculate separately. The time gap can be defined as one or more symbols plus additional time as the following.

$$Gap\_in \_Tc = 140288 * NumberOfSymbol + FractionPartAnother \qquad Eqn . ( 4 )$$

Where, FractionPartAnother can be a time duration within a range, e.g., −64˜+64 Tc. The transmission power of SRS on each CC can be identical. The transmission power (or energy) per resource element (EPRE) of SRS on each CC can be identical. The EPRE can be limited to the maximum transmission power (e.g., 23 dBm) over a CC with the maximum bandwidth of SRS. This will ensure the same coverage of SRS. Alternatively, the EPRE on each CC/FL is identical if one CC/FL has different bandwidth (e.g., 50 MHz+100 MHz+50 MHz).

Thirdly, the UE measures the timing difference between CC. The UE measures the timing difference of SRS between CC. The timing difference of SRS between CC can be defined those as Gap_in_Tc in the second step. The timing difference of SRS between CC can be defined that as FractionPartAnother in the second step, e.g., in a range of −10˜+10 Tc. The UE measures the phase difference between CC. The UE measures the phase difference of SRS between CC.

Fourthly, the UE report the timing difference and/or the phase difference to the network (e.g., LMF, gNB).

Fifthly, the network (e.g., gNB) measures the timing difference between CC. The network (e.g., gNB) measures the timing difference of SRS between CC.

The network (e.g., gNB) measures the joint timing difference of CC between base stations. The network (e.g., gNB) measures the joint timing difference of SRS on CC between base stations. The network (e.g., gNB) measures the joint timing difference of SRS on CC between itself and a reference base stations. The network (e.g., gNB) measures the joint timing difference of SRS on CC between itself and a reference time source. The joint timing difference of SRS on CC can utilize SRS on two or more CC. The joint timing difference of SRS on CC can utilize SRS on two or more CC on different time instances. The joint timing difference of SRS on CC can utilize SRS on two or more CC on identical and/or different time instances (e.g., 2 CC on identical time instances and another 2 CC on different time instances).

The network (e.g., gNB) measures the joint timing difference of CC between TRP from base station(s). The network (e.g., gNB) measures the joint timing difference of SRS on CC between TRP from one or more base station(s). The network (e.g., gNB) measures the carrier phase difference between CC. The network (e.g., gNB) measures the carrier phase difference of SRS between CC. The network (e.g., gNB) measures the joint carrier phase difference of CC between base stations. The network (e.g., gNB) measures the joint carrier phase difference of SRS on CC between base stations. The network (e.g., gNB) measures the joint carrier phase difference of SRS on CC between TRP of base stations. The network (e.g., gNB) measures the joint carrier phase difference of SRS on CC between itself and a reference TRP of base station. The reference TRP has a lowest TRP index. The reference TRP has a TRP index 0. The reference TRP has a PRS-ID 0. Sixthly, the network (e.g., gNB) reports measurement result(s) (e.g., timing difference and/or the phase difference, joint timing difference and/or the joint phase difference) to the network (e.g., LMF) and/or UE as the following figure.

FIG. 7 illustrates a second transmission in accordance with present implementations. As illustrated by way of example in FIG. 7, an example transmission 700 can include a target 710, a server 720, a positioning information request 712, and a positioning information response 722.

It can be noted that, before the network (e.g., gNB) reporting measurement result(s) (e.g., via POSITIONING INFORMATION RESPONSE in the following figure), the network (e.g., LMF) may request the network (e.g., gNB) (e.g., via POSITIONING INFORMATION REQUEST in the following figure) to provide location information (e.g., the measurement result(s) above). Seventhly, the network (e.g., LMF) compute the position of UE according to the measurement result(s) from gNB and/or UE. With this method, the bandwidth of SRS can be enlarged. Hence, the UL-based positioning accuracy can be improved.

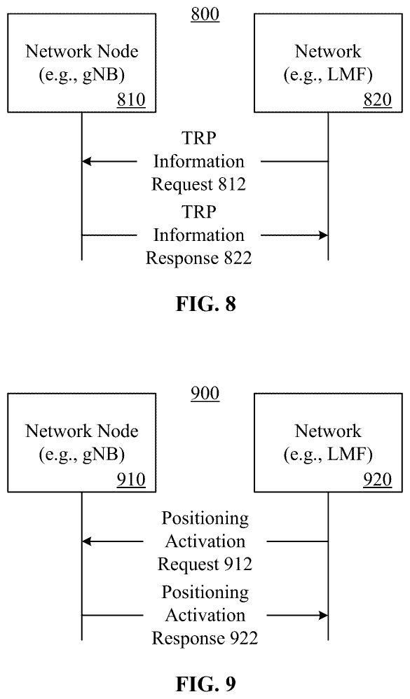

FIG. 8 illustrates a third transmission in accordance with present implementations. As illustrated by way of example in FIG. 8, an example transmission 800 can include a network node 810, a network 820, a TRP information request 712, and a TRP information response 722.

First, the network (e.g., LMF) requests a UE for UE capability of PRS processing window. A PRS processing window can be a time duration outside of a measurement gap (MG). Within this time duration a UE can measure PRS. The PRS processing window can be in a unit of slot (e.g., 10 slots). The PRS processing window can be in a unit of slot (e.g., 10 slots) at a specific SCS (e.g., 15 kHz). The PRS processing window can be in a unit of slot (e.g., 20 slots) at the SCS of a FL/CC. The PRS processing window can be in a unit of slot (e.g., 30 slots) at the SCS of a BWP in a FL/CC. The PRS processing window can be in a unit of slot (e.g., 40 slots) at the SCS of an active BWP in a FL/CC. The PRS processing window can be in a unit of absolute time (e.g., 8 ms). Alternatively, if the SCS of a CC can be different from that of the reference FL/CC, then the PRS processing window can be not applied to this CC. If the SCS of a BWP in a CC can be different from that of the reference FL/CC, then the PRS processing window can be not applied to this BWP in this CC.

Alternatively, the duration (or length) of PRS processing window can be in units of milli-seconds. Alternatively, the duration of PRS processing window is based on the length of PRS processing window for SCS of 15 kHz. For example, the duration of PRS processing window is W=floor (W_15 kHz/(2\hat{ }u)) or W=ceil(W_15 kHz/(2\hat{ }u)) where W_15 kHz is the duration of PRS processing window for SCS of 15 kHz, u is the configuration of SCS (u=0,1,2, . . . ), floor( ) fetches the nearest integer that is not larger than the operand and, ceil( ) fetches the nearest integer that is not less than the operand.

Alternatively, the PRS processing window is with a periodicity. Alternatively, the periodicity of the PRS processing window is in unit of milli-second (ms) or time slot.

Alternatively, the PRS processing window is within a SS/PBCH block measurement timing configuration (SMTC) window. Alternatively, the PRS processing window is within the first SMTC window.

Alternatively, if the SCS of current BWP of a CC can be different from that of the reference FL/CC, then the BWP of this UE can be switched to a BWP with identical SCS of the reference FL/CC to apply the PRS processing window (e.g., via downlink control information, DCI, format 1_1, DCI format 1_2). Alternatively, if the SCS of current BWP of a CC can be different from that can be required (or indicated) by the PRS processing window, then the BWP of this UE can be switched to a BWP with identical SCS that can be required (or indicated) to apply the PRS processing window (e.g., via DCI format 0_1, DCI format 0_2). Alternatively, if the time required for BWP switch will cause the PRS cannot be processed within the PRS processing window, then this PRS processing window can be invalid. Alternatively, if the time required for BWP switch will cause the PRS cannot be processed within the PRS processing window, then this PRS processing window can be invalid for this FL/CC.

The PRS processing window can be less than or equal to the duration of a measurement gap (MG). The PRS processing window can be longer than the duration of a MG (e.g., double). The PRS processing window can be the duration of a MG multiplied by a number of FL/CC. The PRS processing window can be at least as long as the duration of a MG. The PRS processing window can be configured by the network (e.g., LMF). A PRS processing window can be associated with an ID. A PRS processing window can be associated with an window ID (e.g., 0, 1, . . . , 15). A PRS processing window can be associated with a carrier ID (or cell ID, e.g., 0, 1 . . . 31). A PRS processing window can be associated with a CC ID (or serving cell ID, e.g., 0, 1 . . . 63). A PRS processing window can be associated with a frequency band ID (e.g., 0, 1 . . . 8). A PRS processing window can be associated with a PRS resource (set) ID (e.g., 0, 1 . . . 63).

A PRS processing window can be activated by a medium access control (MAC) control element (CE). A PRS processing window can be activated by a DL MAC CE. A PRS processing window can be activated by a UL MAC CE. A PRS processing window can be activated by a DL MAC CE with carrier ID (or cell ID, or serving cell ID). A PRS processing window can be activated by a DL MAC CE with carrier ID of aggregated carrier(s).

Alternatively, if a PRS processing window collides with a SSB, the PRS processing window can be invalid for a UE. Alternatively, if a PRS processing window collides with a SSB on a CC/FL, the PRS processing window can be invalid for a UE. Alternatively, if a PRS processing window collides with a SSB on a CC/FL, the PRS within this PRS processing window can be invalid for a UE. Alternatively, if a PRS processing window collides with a SSB on a CC/FL, the collision PRS within this PRS processing window can be invalid for a UE. Alternatively, if a PRS processing window collides with a SSB on a CC/FL, the collision symbol(s) of PRS within this PRS processing window can be invalid for a UE. Alternatively, if a PRS processing window collides with a SSB on a CC/FL, the collision RE of PRS within this PRS processing window can be invalid for a UE. Alternatively, if a PRS processing window collides with a high priority signal/channel (e.g., PDCCH, PDSCH of URLLC) on a CC/FL, the PRS within this PRS processing window can be invalid for a UE.

Alternatively, the high priority signal or channel is not transmitted when a reference signal for positioning on a frequency layers within a PRS processing window is with a higher priority. For example, the PRS is transmitted and the high priority signal or channel (e.g., PDCCH) is not transmitted. For another example, the PRS is transmitted and the high priority signal or channel (e.g., PDSCH of URLLC) is not transmitted within a PRS processing window. For another example, the PRS is transmitted and the high priority signal or channel (e.g., CSI-RS) is not transmitted on the symbol that transmits PRS, within a PRS processing window. For still another example, the PRS is transmitted and the high priority signal or channel (e.g., PDSCH) is not transmitted on the symbol that is occupied by PRS, within a PRS processing window.

Alternatively, the high priority signal or channel is not transmitted when a reference signal for positioning on a joint of frequency layers within a PRS processing window is with a higher priority.

Alternatively, the high priority signal or channel is not transmitted on a symbol of a reference signal for positioning when the reference signal for positioning on a joint of frequency layers within a PRS processing window is with a higher priority.

Alternatively, the high priority signal or channel is not transmitted on a symbol of a reference signal for positioning when the reference signal for positioning from a same timing error group (TEG) on frequency layers within a PRS processing window is with a higher priority.

Alternatively, the high priority signal or channel is not transmitted on a symbol of a reference signal for positioning when the reference signal for positioning from a same Tx TEG (transmission TEG, e.g., signals from the same TRP) on a joint of frequency layers within a PRS processing window is with a higher priority. Alternatively, the high priority signal or channel is not transmitted on a symbol of a reference signal for positioning when the reference signal for positioning from a same Tx TEG indicated (or required, or requested) by the network (e.g., LMF) on a joint of frequency layers within a PRS processing window is with a higher priority.

Secondly, the UE reports its UE capability of PRS processing window to the network (e.g., gNB, LMF). Alternatively, this UE capability of PRS processing window can include a maximum aggregated DL PRS bandwidth. Alternatively, this UE capability of PRS processing window can include a maximum aggregated DL PRS bandwidth over all the FL/CC. Alternatively, this UE capability of PRS processing window can include a maximum aggregated DL PRS bandwidth over all the FL/CC on FR 1 and/or FR 2. For example, if one UE supports two FL with 100 MHz each on FR 1, then the maximum aggregated DL PRS bandwidth can be 200 MHz. For another example, if one UE supports three FL with 400 MHz each on FR 2, then the maximum aggregated DL PRS bandwidth can be 1200 MHz.

The UE reports its UE capability of DL PRS buffering. It can be Type 1 (e.g., sub-slot/symbol level buffering) or Type 2 (e.g., slot level buffering). Alternatively, this UE capability of DL PRS buffering can be across over all the FL/CC (e.g., for Type 1 buffering with S=4 symbols for one FL/CC, then it will be floor(S/NumberOfCC) symbols for all the FL/CC where the NumberOfCC can be the number of FL/CC). Alternatively, this UE capability of DL PRS buffering can be per FL/CC based (e.g., for Type 2 buffering with U=4 slots for a FL/CC, then it will be U*NumberOfCC slots for all the FL/CC).

The UE reports its UE capability of duration of DL PRS symbols N in units of millisecond a UE can process every T millisecond assuming maximum DL PRS bandwidth in MHz. The N can be {0.125, 0.25, 0.5, 1, 2, 4, 6, 8, 12, 16, 20, 25, 30, 32, 35, 40, 45, 50, 1001 ms. The T can be the periodicity of PRS (e.g., 64 ms). The T can be the duration of PRS processing window (e.g., 6 ms. Here, the N≤T). Alternatively, this UE capability can be defined across all the FL/CC that this UE support (e.g., for one specific FL/CC, the duration of DL PRS symbols can be N/NumberOfCC). Alternatively, this UE capability can be defined per FL/CC (e.g., if this UE supports NumberOfCC FL/CC, then the duration of DL PRS symbols can be N*NumberOfCC).

The UE reports its UE capability of maximum number of DL PRS resources that UE can process in a slot. For example, it can be W={1, 2, 4, 6, 8, 12, 16, 24, 32, 48, 64, 128, 256, 512, 10241 resource(s) for each SCS. Alternatively, this UE capability can be defined across all the FL/CC that this UE support (e.g., for one specific FL/CC, the maximum number of DL PRS resources can be W/NumberOfCC). Alternatively, this UE capability can be defined per FL/CC that this UE support (e.g., for one specific FL/CC, the maximum number of DL PRS resources can be W*NumberOfCC).

The UE reports its UE capability of PRS computation time. The UE reports its UE capability of PRS computation time for one FL/CC. The UE reports its UE capability of PRS computation time for each of FL/CC. The UE reports its UE capability of PRS computation time for aggregated FL/CC. The UE reports its UE capability of PRS computation time for aggregated FL/CC as a whole. The PRS computation time can include PRS measuring time. The PRS computation time can include channel preparation time. The PRS computation time can include channel preparation time before it can be ready for measurement.

A UE can indicate frequency band(s) that support(s) PRS processing window. The PRS processing window can be identical over all the frequency bands. The PRS processing window overlaps over all the frequency bands. The PRS processing window fully overlaps over all the frequency bands. The PRS processing window partially overlaps over all the frequency bands.

The PRS processing window can be identical over all the FL/CC within a frequency band. The PRS processing window overlaps over all the FL/CC within a frequency band. A UE can indicate carrier index (or serving cell index) of a frequency band that supports PRS processing window. The network (e.g., LMF) requests a UE for UE capability of PRS processing window as the “POSITIONING INFORMATION REQUEST.” The UE report its UE capability of PRS processing window as the “POSITIONING INFORMATION RESPONSE” in the following figure.

Thirdly, the network (e.g., LMF) requests a network node (e.g., gNB) for PRS processing window information. The network (e.g., LMF) requests a network node (e.g., gNB) for PRS processing window information on aggregation of FL/CC. Alternatively, this information on aggregation of FL/CC can be based on aggregated bandwidth of all the FL/CC. Alternatively, this information on aggregation of FL/CC can be based on number of aggregated FL/CC. Alternatively, each of aggregated FL/CC can be associated with a TRP. Alternatively, each of aggregated FL/CC can be associated with a TRP ID (or PRS-ID).

Alternatively, for a UE with a processing type of capability 1B (i.e., only the DL signals/channels from a certain band/CC are affected), the PRS processing window can be not applied to the band/CC that are not affected (by PRS). Alternatively, for a UE with a processing type of capability 1B, the PRS processing window can be applied to the band/CC that are affected (by PRS).

Alternatively, for a UE with two priority states: A. PRS can be higher priority than all physical downlink control channel (PDCCH)/physical downlink shared channel (PDSCH)/CSI-RS, B. PRS can be lower priority than all PDCCH/PDSCH/CSI-RS, if this UE can be indicated with priority state B, then the network (e.g., LMF, gNB) will not configure PRS processing window for this UE. Alternatively, if this UE can be indicated with priority state B, then the configured PRS processing window can be invalid for this UE. Alternatively, if this UE can be indicated with priority state B, then the configured PRS processing window can be invalid for this UE on a specific FL/CC. Alternatively, if this UE can be indicated with priority state B, then the configured PRS processing window can be invalid for this UE on a specific FL/CC that PRS has collision with PDCCH/PDSCH/CSI-RS.

Alternatively, for a UE with three priority states: A. PRS can be higher priority than all PDCCH/PDSCH/CSI-RS, B. PRS can be lower priority than PDCCH and ultra reliable low latency communication (URLLC) PDSCH and higher priority than other PDSCH/CSI-RS, C. PRS can be lower priority than all PDCCH/PDSCH/CSI-RS, if this UE can be indicated with priority state B or C, then the network (e.g., LMF, gNB) will not configure PRS processing window for this UE. Alternatively, if this UE can be indicated with priority state B and an overlapping with PDCCH/URLLC PDSCH, then the network (e.g., LMF, gNB) will not configure PRS processing window for this UE. The network (e.g., LMF) can request the PRS processing window information with TRP INFORMATION REQUEST.

Fourthly, the network node (e.g., gNB) provides PRS processing window information to the network (e.g., LMF) and/or UE. The network node (e.g., gNB) provides PRS processing window information with TRP INFORMATION RESPONSE.

Fifthly, the network node (e.g., gNB) transmits PRS on its TRP. The network node (e.g., gNB) transmits PRS on FL/CC indicated by the network (e.g., LMF). The network node (e.g., gNB) transmits PRS on FL/CC coherently. The network node (e.g., gNB) transmits PRS on FL/CC coherently with identical phase. The network node (e.g., gNB) transmits PRS on FL/CC coherently within a range of phase shift (e.g., less thanπ/1000). The network node (e.g., gNB) transmits PRS on FL/CC coherently with identical start time. The network node (e.g., gNB) transmits PRS on FL/CC coherently within a range of start time (e.g., less than 0.01 ns).

The network node (e.g., gNB) measures an actual time difference between FL/CC that carries PRS. The network node (e.g., gNB) measures an actual phase difference between FL/CC that carries PRS. The network node (e.g., gNB) reports the actual time difference between FL/CC that carries PRS. The network node (e.g., gNB) reports the actual phase difference between FL/CC that carries PRS.

Sixly, a UE measures PRS from multiple gNB on a PRS processing window. A UE measures PRS from multiple TRP of a gNB on a PRS processing window. A UE measures time difference(s) of PRS between gNB on a PRS processing window. A UE measures time difference(s) of PRS between TRP of gNB on a PRS processing window. A UE measures time difference(s) on aggregated FL/CC of PRS between TRP of gNB on a PRS processing window.

A UE measures phase difference(s) (or carrier phase difference, or sub-carrier phase difference) of PRS between gNB on a PRS processing window. A UE measures phase difference(s) of PRS between TRP of gNB on a PRS processing window. A UE measures phase difference(s) on aggregated FL/CC of PRS between TRP of gNB on a PRS processing window. Seventhly, a UE reports the measurement result(s) above to the network (e.g., gNB, LMF). With this method, the DL-based positioning accuracy can be improved.

A UE measures phase difference(s) (or carrier phase difference, or sub-carrier phase difference) with the same TEG (e.g., from the same TRP/panel). A UE measures phase difference(s) (or carrier phase difference, or sub-carrier phase difference) with the same receiving TEG (Rx-TEG).

FIG. 9 illustrates a fourth transmission in accordance with present implementations.

For the case of multiple CC transmission of SRS for positioning from UE, the network (e.g., LMF) can make one (or more) network node(s) (e.g., gNB) and UE be prepared. First, the network (e.g., LMF) requests the network node(s) (e.g., gNB) for uplink SRS based positioning. The SRS for positioning has one or more CC. The SRS for positioning has one or more SRS resource (set) on one or more CC. Secondly, network node (e.g., gNB) indicates UE to transmit SRS for positioning. Thirdly, the UE transmits SRS for positioning. Alternatively, UE transmits SRS for positioning on multiple CC. The SRS for positioning one these CC are transmitted coherently. The SRS for positioning one different CC are transmitted within a time drift limit (e.g., 0.1 ns).

Fourthly, the network node (e.g., gNB) measures the SRS for positioning from one or more UE. Fifthly, the network node (e.g., gNB) reports the measurement result(s) to the network (e.g., LMF). The measurement result(s) include(s) measurement result(s) on SRS of multiple CC. The network (e.g., LMF) requests the network node(s) (e.g., gNB) for uplink SRS based positioning via POSITIONING ACTIVATION REQUEST message as the following figure. Alternatively, if the network node(s) (e.g., gNB) successfully active(s) transmission of SRS for positioning (e.g., getting valid measurement result(s)), the network node(s) (e.g., gNB) provide(s) POSITIONING ACTIVATION RESPONSE as the following figure. Alternatively, the network node(s) (e.g., gNB) provide(s) measurement result(s) on POSITIONING ACTIVATION RESPONSE. With this method, the DL-based positioning accuracy can be improved.

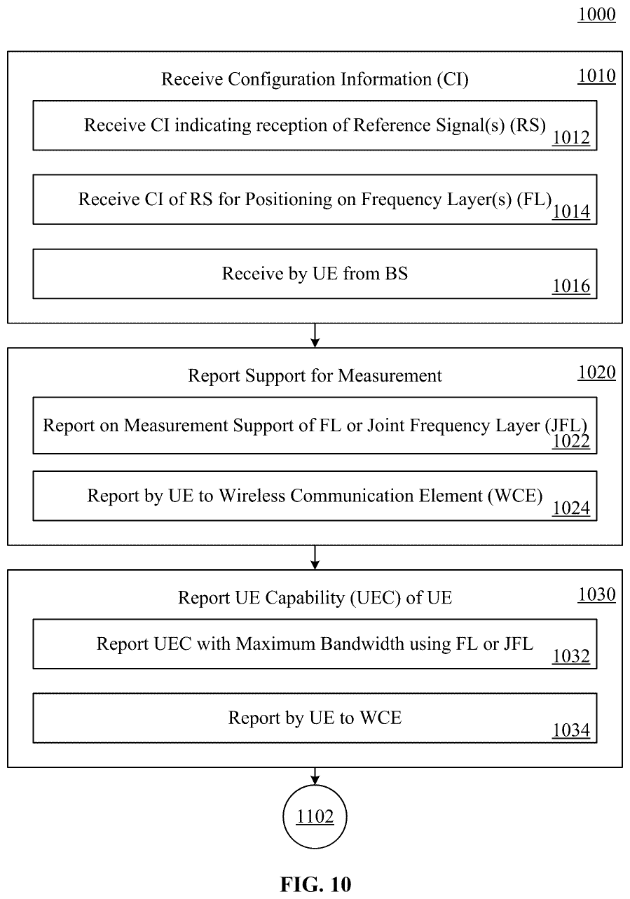

FIG. 10 illustrates a first method of communicating reference signals for positioning in accordance with present implementations. At least one of the example systems 100 and 200 can perform method 1000 according to present implementations. The method 1000 can begin at step 1010.

At step 1010, the method can receive configuration information. Step 1010 can include at least one of steps 1012, 1014 and 1016. At step 1012, the method can receive configuration information indicating reception of one or more reference signals. At step 1014, the method can receive configuration information indicating reception of one or more reference signals for positioning on one or more frequency layers. At step 1016, the method can receive configuration information by a user equipment from a base station. The method 1000 can then continue to step 1020.

At step 1020, the method can report support for measurement. Step 1020 can include at least one of steps 1022 and 1024. At step 1022, the method can report on support for measurement of positioning based on frequency layers or a joint frequency layer. At step 1024, the method can report by user equipment to a wireless communication element. The method 1000 can then continue to step 1030.

At step 1030, the method can report a capability of a particular user equipment. Step 1030 can include at least one of steps 1032 and 1034. At step 1032, the method can report a capability including a maximum bandwidth associated with the user equipment with respect to one or more of a plurality of frequency layers and a joint frequency layer. At step 1034, the method can report by the user equipment to a wireless communication element. The method 1000 can then continue to step 1102.

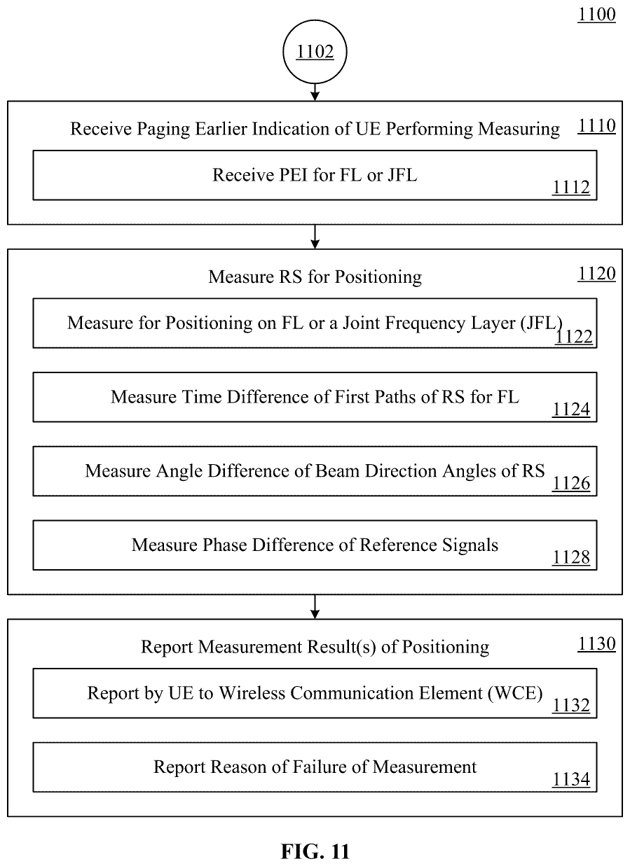

FIG. 11 illustrates a second method of communicating reference signals for positioning further to the method of FIG. 10. At least one of the example systems 100 and 200 can perform method 1100 according to present implementations. The method 1100 can begin at step 1102. The method 1100 can then continue to step 1110.

At step 1110, the method can receive a paging indication of the user equipment performing the measuring. Step 1110 can include step 1112. At step 1112, the method can receive a paging indication for one or more of a plurality of frequency layers and a joint frequency layer. The method 1100 can then continue to step 1120.

At step 1120, the method can measure one or more reference signals for positioning. Step 1120 can include at least one of steps 1122, 1124, 1126 and 1128. At step 1122, the method can measure for positioning on one or more frequency layers or a joint frequency layer. At step 1124, the method can measure a time difference of first paths of reference signals with respect to one or more frequency layers. At step 1126, the method can measure an angle difference of beam direction angles of one or more reference signals. At step 1128, the method can measure a phase difference of reference signals. The method 1100 can then continue to step 1130.

At step 1130, the method can report measurement results of positioning. Step 1130 can include at least one of steps 1132 and 1134. At step 1132, the method can report by user equipment to a wireless communication element. At step 1134, the method can report a reason of failure of measurement, where the measurement fails. The method 1100 can end at step 1130.

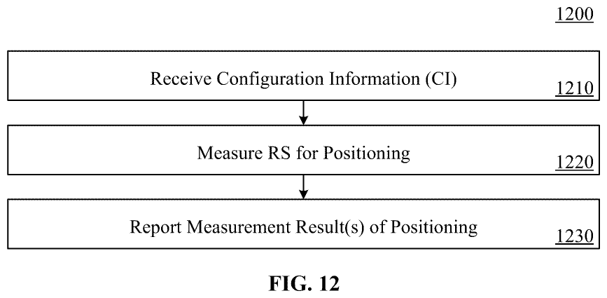

FIG. 12 illustrates a third method of communicating reference signals for positioning in accordance with present implementations. At least one of the example systems 100 and 200 can perform method 1200 according to present implementations. The method 1200 can begin at step 1210. At step 1210, the method can receive configuration information. Step 1210 can correspond at least partially to step 1010. The method 1200 can then continue to step 1220. At step 1220, the method can measure one or more reference signals for positioning. Step 1220 can correspond at least partially to step 1120. The method 1200 can then continue to step 1230. At step 1230, the method can report measurement results of positioning. Step 1230 can correspond at least partially to step 1130. The method 1200 can end at step 1230.

The herein described subject matter sometimes illustrates different components contained within, or connected with, different other components. It is to be understood that such depicted architectures are illustrative, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general, such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Further, unless otherwise noted, the use of the words “approximate,” “about,” “around,” “substantially,” etc., mean plus or minus ten percent.

The foregoing description of illustrative implementations has been presented for purposes of illustration and of description. It is not intended to be exhaustive or limiting with respect to the precise form disclosed, and modifications and variations are possible in light of the above teachings or may be acquired from practice of the disclosed implementations. It is intended that the scope of the invention be defined by the claims appended hereto and their equivalents.

1. A wireless communication method, comprising:
receiving, by a wireless communication device from a wireless communication node, configuration information indicating receptions of a plurality of reference signals for positioning on a plurality of frequency layers;
measuring, by the wireless communication device, the reference signals for positioning on the frequency layers or a joint of frequency layers; and
reporting, by the wireless communication device to a wireless communication element, a measurement result of the reference signals for positioning on the frequency layers or the joint of frequency layers.

2. The wireless communication method of claim 1, wherein the configuration information further indicates a Quasi-Co-Location (QCL) relationship of the reference signals for positioning among the plurality of frequency layers.

3. The wireless communication method of claim 2, wherein the QCL relationship indicates that a first one of the reference signals for positioning on a first one of the plurality of frequency layers is Quasi-Co-Located (QCL'ed) with a synchronization signal or a physical broadcast channel block (SSB) on a second one of the plurality of frequency layers; or
wherein the QCL relationship indicates that the a first one of the reference signals for positioning on a first one of the plurality of frequency layers is Quasi-Co-Located (QCL'ed) with a Channel State Information Reference Signal (CSI-RS) on a second one of the plurality of frequency layers.

4. (canceled)

5. The wireless communication method of claim 1, further comprising:
prior to the step of measuring the reference signals for positioning, reporting, by the wireless communication device to the wireless communication element, whether the wireless communication device supports measurements of the reference signals for positioning on multiple frequency layers or a joint of frequency layers.

6. The wireless communication method of claim 1, wherein the step of measuring the reference signals for positioning further comprises at least one of:
measuring, by the wireless communication device, a time difference between respective first paths of the reference signals for positioning on two corresponding ones of the frequency layers;
measuring, by the wireless communication device, a time difference between respective first paths of the reference signals for positioning with PRS ID on two corresponding ones of the joint of frequency layers;
measuring, by the wireless communication device, an angle difference between respective beam direction angles of two of the reference signals for positioning that are QCL'ed with each other, wherein both the reference signals for positioning are associated with a same QCL source;
measuring, by the wireless communication device, a phase difference between two of the reference signals for positioning on two corresponding ones of the frequency layers; or
measuring, by the wireless communication device, a phase difference between two of the reference signals for positioning on two corresponding ones of the frequency layers, while measuring, by the wireless communication device, a time difference of the two reference signals for positioning.

7-10. (canceled)

11. The wireless communication method of claim 1, wherein the step of reporting a measurement result further comprises:
reporting, by the wireless communication device to the wireless communication element, a reason of failure on performing the step of measuring the reference signals for positioning where the reference signals for positioning are on the joint of frequency layers.

12. The wireless communication method of claim 11, wherein the reason includes at least one of: no support of aggregation of the plurality of frequency layers, temporarily no support of aggregation of the plurality of frequency layers, a bandwidth limitation, a radio frequency chain absence, a low signal strength, or an out-of-range measured value.

13. The wireless communication method of claim 1, wherein the step of measuring the reference signals for positioning further comprises:
measuring, by the wireless communication device, a Downlink Reference Signal Time Difference (DL RSTD) between the reference signals for positioning on two corresponding ones of the frequency layers or on the joint of frequency layers.

14. The wireless communication method of claim 1, further comprising:
prior to the step of measuring the reference signals for positioning, reporting, by the wireless communication device to the wireless communication element, a User Equipment (UE) capability of the wireless communication device, wherein the UE capability includes a maximum bandwidth the wireless communication device can process after aggregation of the frequency layers.

15. The wireless communication method of claim 1, further comprising:
receiving, by the wireless communication device through the wireless communication element from another wireless communication node, one or more measurement results associated with the frequency layers, wherein the another wireless communication node is a non-serving gNB.

16. The wireless communication method of claim 1, further comprising:
receiving, by the wireless communication device, a Paging Earlier Indication (PEI) indicating the wireless communication device to perform the step of measuring when in an RRC_Inactive state or an RRC_Idle state.

17. The wireless communication method of claim 1 further comprising:
receiving, by the wireless communication device, a PEI indicating the wireless communication device to perform the step of measuring on a single one of the frequency layers or on the joint of frequency layers.

18. The wireless communication method of claim 1, wherein the measurement result is associated with at least one of: Absolute Radio Frequency Channel Number (ARFCN), transmission reception point (TRP) identification (TRPID), PRS-ID, PRS-Resource-ID, or PRS-Resource-Set-ID.

19. The wireless communication method of claim 1, wherein the measurement result is associated with one of: a single one of the frequency layers, the joint of frequency layers, or a combination of multiple ones of the frequency layers.

20. The wireless communication method of claim 1, wherein the wireless communication device is configured to measure one or more of the reference signals for positioning on the corresponding ones of the frequency layers that each have a high priority.

21. The wireless communication method of claim 1, wherein the wireless communication device is configured to measure the reference signals for positioning within a processing window that is associated with a carrier ID or cell ID.

22. The wireless communication method of claim 1, wherein the wireless communication device is configured to measure the reference signals for positioning within a processing window that is associated with an ID of a resource or resource set configured for the reference signals for positioning.

23. The wireless communication method of claim 1, wherein the step of reporting the reference signals for positioning further comprises:
the wireless communication device reports the carrier phase of reference signal for positioning on a frequency layer with an indication of line of sight (LOS)/non-LOS (NLOS).

24. The wireless communication method of claim 1, wherein the step of reporting the reference signals for positioning further comprises:
the wireless communication device reports the carrier phase difference of reference signal for positioning on a frequency layer with an indication of line of sight (LOS)/non-LOS (NLOS).

25-33. (canceled)

34. A wireless communication apparatus comprising at least one processor and a memory, wherein the at least one processor is configured to read code from the memory and implement the method recited in claim 1.

35. (canceled)
